(19) United States
(12) Patent Application Publication
(10) Pub. No.: US 2012/0070793 A1
(43) Pub. Date: Mar. 22, 2012

(54) Self supporting kiln insulation covers

(76) Inventor: Mark A. Thompson, Midland, MI (US)

(21) Appl. No.: 13/373,035

(22) Filed: Nov. 2, 2011

Related U.S. Application Data
(63) Continuation-in-part of application No. 12/322,384, filed on Feb. 2, 2009.
(60) Provisional application No. 61/066,251, filed on Feb. 19, 2008.

(51) Int. Cl. F27B 7/00; B23P 11/00

(52) U.S. Cl. 432/103; 29/428

(57) ABSTRACT

Self supporting kiln insulation device comprising an outer layer having an inside surface, at least two insulation modules, and, a stationary support structure. The insulation modules do not touch the kiln and heat dams are located adjacent to and touching the kiln, and are spaced at random spacing along the kiln.

This application is an original application based on U.S. Provisional patent application having Ser. No. 61/066,251, filed on Feb. 19, 2008 and U.S. Utility patent application having Ser. No. 12/322,384 filed on Feb. 2, 2009.

The invention disclosed and claimed herein deals with a new insulation device that is a self supporting kiln insulation cover.

### BACKGROUND OF THE INVENTION

Commonly used at cement and asphalt plants, kilns, especially rotary kilns are found in many manufacturing processes, including the chemical, pharmaceutical, food processing, agricultural and highway material industries. Rotary kilns are large horizontal cylinders set up on a slight angle, rotating to mix materials together and depending on gravity to work the material down the length of the kiln. Rotary kilns can range from 30 to 800 feet in length and range between 12 and 20 feet in diameter.

Rotary kilns are not the only structures for kilns, as kilns for various manufacturing processes take on other configurations, such as square, triangular, etc.

Kilns are fueled by materials such as petroleum, natural gas, oil, coal, and even used tires and other industrial waste. The kilns operate at high temperatures in order for chemical reactions to occur and the gas flame shooting down the middle of the tube-like structure can often reach 3400° F. (1870° C.), about one third of the temperature of the sun's surface. With the heat of this machine reaching such extremes, the question of energy efficiency is often associated with kilns.

Kilns are insulated with firebrick sandwiched in between the outside metal cylinder and the inside layer. This structure allows for the outside shell to still become very hot, and some studies suggest that an estimated forty percent of total input energy is being lost. Attempts to conserve this energy have been made in the past, but most of them have consisted of putting insulation directly on the surface of the outside rotating shell. Over a period of time, this resulted in a sagging egg shaped layer of insulation hanging around the kiln.

Such insulation methods can be found for example, in U.S. Pat. No. 4,932,863 that issued on Jun. 12, 1990 to Anderson, in which a drum dryer for use in the manufacture of bituminous concrete asphalt is provided with a jacket that is insulated. The jacket is strapped directly to the outside of the drum wall.

In addition, U.S. Pat. No. 5,695,329, that issued Dec. 9, 1997 to Orcutt, deals with a jacket that is mechanically attached to the outside surface kiln brick, but underneath the outside wall of the kiln.

With the cost of energy quickly rising, the need for a new rotary kiln invention is in high demand.

### THE INVENTION

Thus, what is disclosed and claimed herein is a self-supporting kiln insulation cover, said self-supporting kiln insulation cover comprising in combination an outer layer having an inside surface, said insulation layer comprised of at least two insulation modules attached to the inside surface; at least two heat dams, and, a stationary support structure for the self-supporting kiln insulation cover.

The insulation 6 is located adjacent to the outer layer, on the inside surface thereof, such that the insulation does not touch the kiln. The insulation cover is provided in modules 31 as is shown in FIG. 1. The modules 31 can be of any convenient size, based on availability of materials, high and low heat transition areas, and the like. Typically, the modules 31 are sized such that they can be handled by workman, and are not so large that their weight tends to separate a long distance from the kiln. The modules 31 fit to the kiln between the dams at the surface of the kiln. The heat dams are located adjacent to and touching the kiln, and are spaced at random distances apart from each other.

The stationary support structure is located so as to support the self supporting kiln insulation cover independent of the kiln.

### BRIEF DESCRIPTION OF THE DRAWINGS

FIG. 1 is a full side view of an insulated rotary kiln of this invention.

FIG. 2 is a cross sectional end view through line A-A of FIG. 1.

FIG. 3A is an enlarged section of FIG. 2 at point Q.

FIG. 3B is an enlarged section of FIG. 4 at point P.

FIG. 4 is a cross sectional end view through line B-B of FIG. 1.

FIG. 5 is a full view of a V-shaped heat dam.

FIG. 6 is a full view of an I-shaped heat dam.

FIG. 7 is a full view of an inverted V-shaped heat dam.

### DETAILED DESCRIPTION OF THE DRAWINGS

This invention consists of an outer supported structure floating over the kiln, supported by a stationary support system. Inside the stationary cover, insulation modules are used to keep an air gap between the insulated cover and the kiln. Keeping the two apparatii from touching each other guarantees a long production life and creates a smaller chance for physical damage to occur.

Air is a good insulator when it is controlled. In the instant invention, the air continues to recycle itself, flowing between the two structures. The design calls for thermal dams placed strategically along the kiln at random distances apart, specifically taking into consideration the heat transition areas and other areas in need of support. The dams wear against the side of the kiln, but can be easily replaced. There is minimal, or no contact of the insulation cover with the kiln surface, eliminating the chance of abrasion and deformation of the insulation. The kiln rotates inside of the insulation cover.

In this invention, it is best if most of the insulation is in the top and the sides of the kiln cover, due to the fact that heat rises.

It is contemplated within the scope of this invention to use an air recycling system to preheat materials, taking hot air from in between the jacket and the actual kiln. This is used to heat the raw mix of materials and get it ready for the kiln. This is very similar to a gas-suspension pre-heater using cyclones to create an energy reaction in the raw mix. This essentially reduces the amount of heat that is wasted to the atmosphere and lets the kiln produce a higher output.

This creates a more energy efficient machine, and the overall process becomes more productive. In order for the kiln to operate efficiently, conditions must remain constant throughout the machine. To ensure productivity, the temperature of the material and the gas must be optimized and maintained at all times.

The instant invention is not limited by the design of the kiln and is not limited by the type of insulation that is used therein. Such insulation can be, for example, Fiberglass, glass fiber, mineral wool, foam glass, cellular glass, ceramic fiber, and polyisocyanurates, to name a few. For purposes of this invention, a combination of the insulations can be used, for example, one module along the kiln can have ceramic insulation while the adjacent module may have glass fiber, and so on.

Companies furnishing such materials are well-known and are, for example, Tempmat, Trymer, Hi-Therm, Saint Gobain, John's Manville, Owens Corning, Roxual, Fibrex, Pittsburg Corning, Zhejiiang Zehnshen Cold Insulation Technology, and Jiaxing Zehnhua Heat.

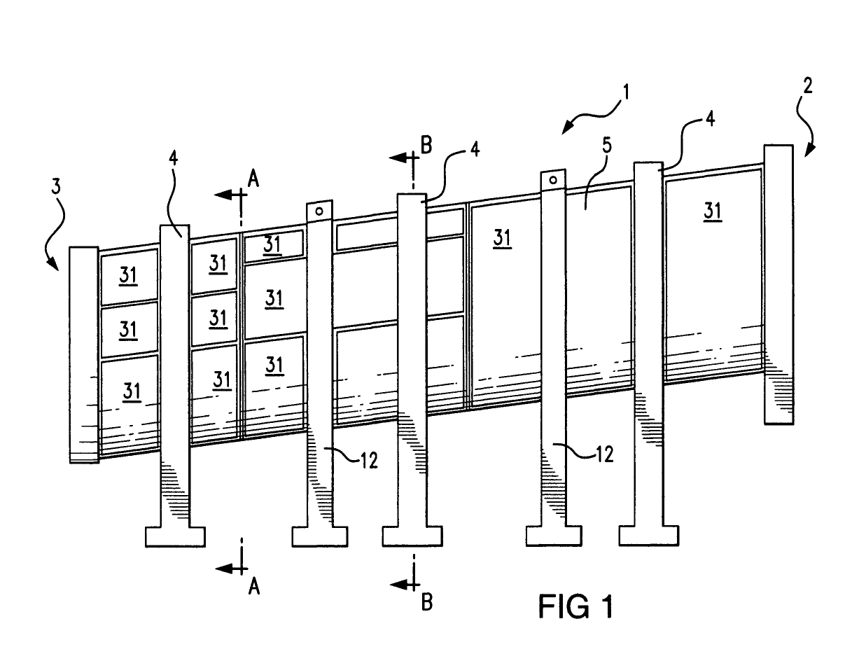

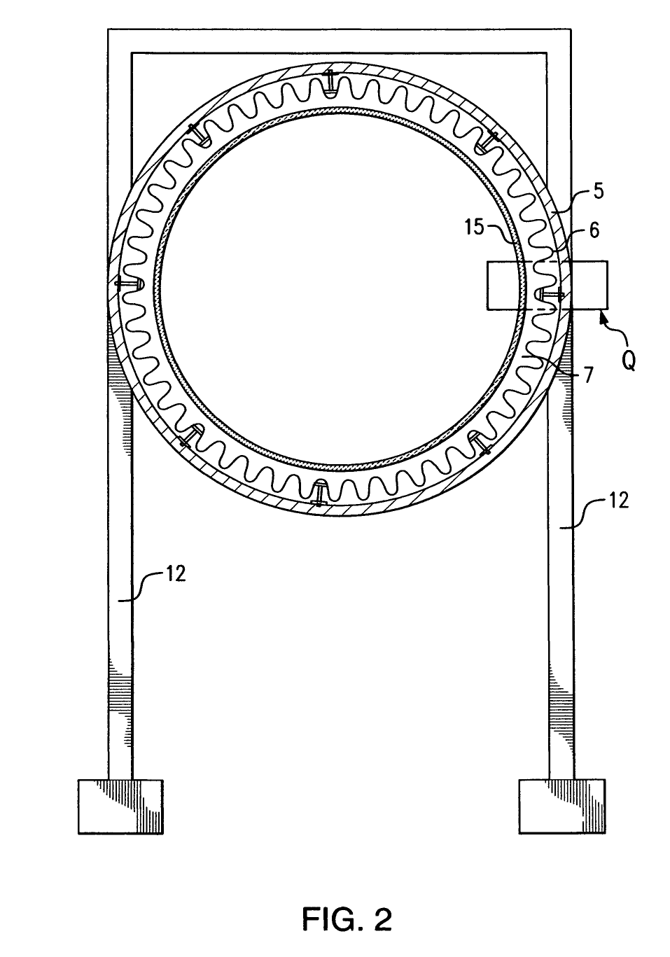

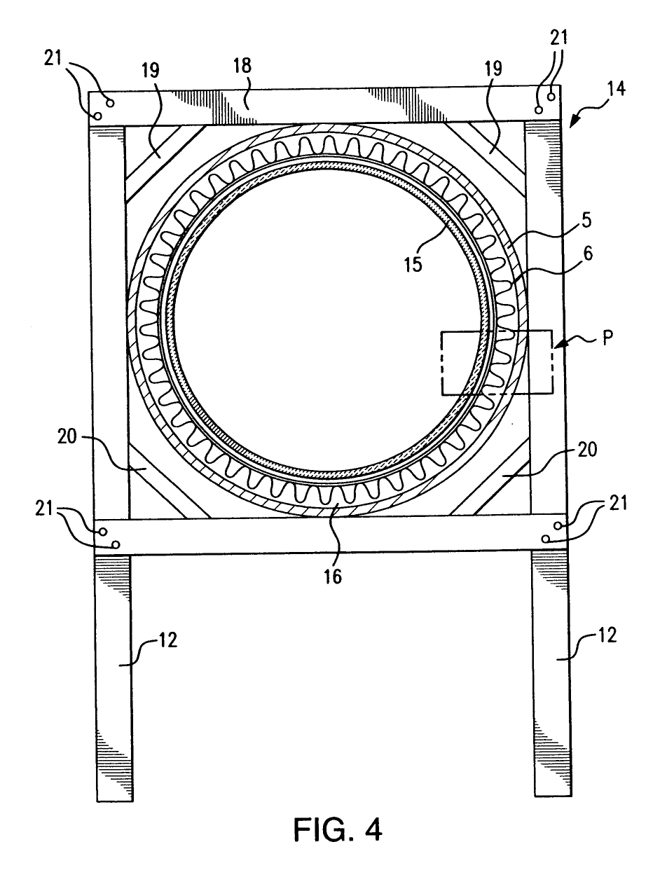

Turning now to FIG. 1, there is shown a full side view of an insulated rotary kiln 1 in which the feed end is located at 2 and the exit end at 3, showing a plurality of modules of insulation. The insulated kiln 1 is supported by a kiln support structure 4. This kiln support structure 4 is also shown in FIG. 4. The stationary support structure for the insulation cover 1 is shown in this Figure as 12, and it can be found in FIG. 2 as well.

The outer covering, or shell 5, of the insulation cover 1, can be observed in FIG. 1 and FIG. 2. The outer shell 5 can be fabricated from plastic, metal, rubber, ceramics, concrete, mortar, brick, wood, and, asphalt, or any other convenient material as long as one takes into consideration the amount of heat that is generated by the end use for the kiln. Plastics can be used and such plastics can be selected from polyethylene, cross-linked polyethylene, polypropylene, urethane, and, Polyester to name a few. Preferred metals can be, for example, Aluminum, Steel, Iron, Tin, and, Magnesium.

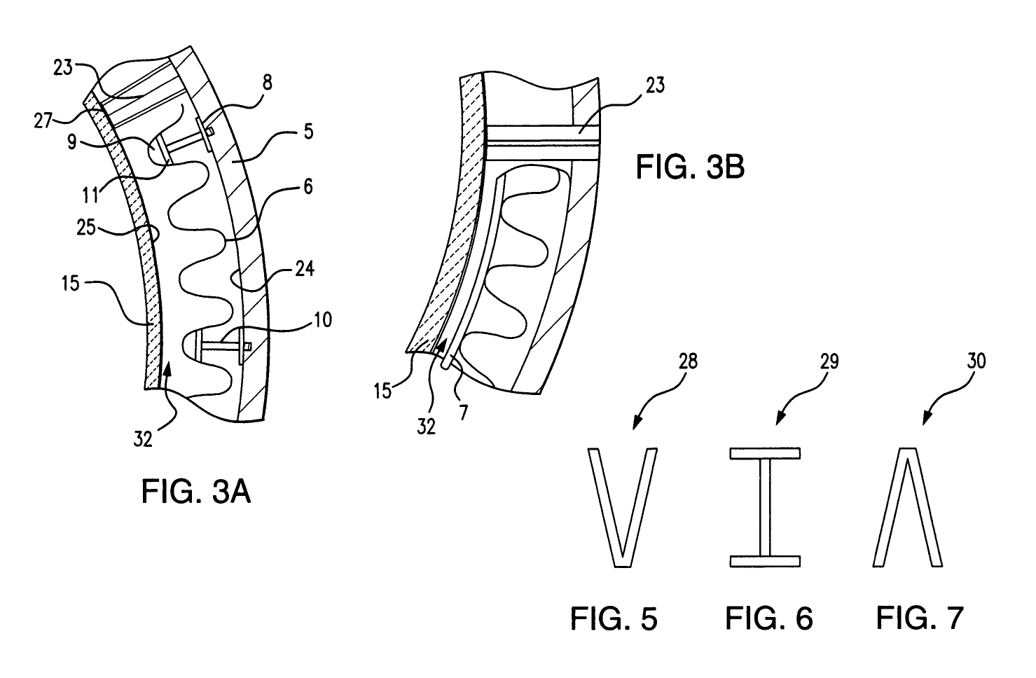

FIG. 2 is a cross sectional view of the insulated kiln 1 at line A-A of FIG. 1 showing the use of stationary legs 12 for support of the insulation cover 1, This Figure shows the outer shell 5, the insulation 6, the kiln 15, and the use of the inner support 7 which is shown in detail in FIG. 3B which is portion Q of FIG. 2.

For purposes of this invention, there can be used an inner support 7, or there can be a another mode of supporting the insulation 6, for example, and with reference to FIG. 3A which is an enlarged portion under the portion P in FIG. 4, the support can be by hangers 8 that are supported by the outer shell 5. The opposite end 9 contacts the outer shell 5 and contains a pin 10 to support the insulation 6, or there is a pin and plate 11 combination, all as shown in FIG. 3A.

Support layer 7 can be for example hardware cloth, chicken wire, or some other open spaced net or wires that will hold the insulation 6 in place.

It should be understood that both the pin 10 and the pin and plate 11 combination are shown, but this is for illustration purposes only and only one or the other of these modes of support need be used.

For purposes of this invention, one can use the support mechanism for the insulation 6 as is shown in FIG. 3A, or one can use an inner covering 7, or both.

It should be noted that the portion of the cross section shown in FIG. 2 shows support legs 12 for the insulation cover and does not show the support frame 14 for the kiln per se.

Turning now to FIG. 4, which is a cross sectional view of the invention through line B-B of FIG. 1, there is shown another embodiment of support for the invention.

Thus, there is shown a rack or frame 14 for supporting the insulation 6 around the actual kiln 15. The rack 14 consists of legs 12 that project above the bottom 16 of the kiln and which are attached to each other by cross bars 17 and 18. There is also shown braces 19 and 20 and fasteners 21 in the portions of the rack 14 where the cross bars 17 and 18 meet the legs 12, both at the top and the bottom.

Returning to FIG. 3A, there is shown a heat dam 23 of this invention. The heat dam 23 is fastened into the inner surface 24 of the cover 5 and projects towards the outer surface 25 of the actual kiln 15 or in some insulations, it can be pressure fitted without actual pinning. The end 27 of the heat dam 23 actually touches the outer surface 25 of the actual kiln 15. It is designed so that it touches very lightly against the surface 25 such that very little heat escapes around it, but does not touch hard enough to create excessive wear on either the heat dam 23 or the outer surface 25 of the actual kiln 15. The heat dams are designed to be removed and replaced.

Most effective seems to be the dam 23 as shown in FIG. 3A and 3B wherein the dam of FIG. 5 is shown in FIG. 3A and the dam of FIG. 7 is shown in FIG. 3B, however, it is contemplated within the scope this invention to use other configurations for the heat dam 23, for example in FIGS. 5, 6, and 7 wherein it is shown a V-shaped dam 28, an I-shaped dam 29 and an inverted V-shaped dam 30.

The heat dams 23, or 28, 29 and 30 can be randomly spaced along the outer surface 25 of the actual kiln 15 and these dams 23 completely circumferentially surround the actual kiln 15. Typically, these heat dams are spaced from 6 feet to 12 feet apart from each other, however, it is common to place them in an area that may be susceptible for losing heat, such as a transitional area of the kiln 15 and thus, they may not and are not required to have even spacing from each other.

What is claimed is:

1. A self-supporting kiln insulation cover, said self-supporting kiln insulation cover comprising in combination an outer layer having an inside surface, said insulation layer comprised of at least two insulation modules attached to the inside surface and, a stationary support structure for the self-supporting kiln insulation cover.

2. In combination, the self-supporting kiln insulation cover as claimed in claim 1 and at least two heat dams.

3. The self-supporting kiln insulation cover as claimed in claim 1 wherein the insulation cover is formed into a module.

4. The self supporting kiln insulation device as claimed in claim 1, wherein the outer layer is fabricated from a material selected from the group consisting essentially of
i. plastic,
ii. metal,
iii. rubber,
iv. ceramics,
v. concrete,
vi. mortar,
vii. brick,
viii. wood, and,
ix. asphalt

5. The self supporting kiln insulation device as claimed in claim 4, wherein the plastic is selected from the group consisting of:
i. polyethylene,
ii. crosslinked polyethylene,
iii. polypropylene,
iv. urethane, and,
v. Polyester.

6. The self supporting kiln insulation device as claimed in claim 4 wherein the plastic is reinforced.

7. The self supporting kiln insulation device as claimed in claim 5 wherein the plastic is reinforced with fiber.

8. The self supporting kiln insulation device as claimed in claim 4, wherein the metal is selected from the group consisting of:
i. Aluminum,
ii. Steel,
iii. Iron,
iv. Tin, and,
v. Magnesium.

9. The self supporting kiln insulation device as claimed in claim 8 wherein the metal is aluminum.

10. The self supporting kiln insulation device as claimed in claim 8 wherein the metal is steel.

11. The self supporting kiln insulation device as claimed in claim 1 wherein the insulation is fabricated from glass fibers.

12. The self supporting kiln insulation device as claimed in claim 1 wherein the insulation is fabricated from foam.

13. The self supporting kiln insulation device as claimed in claim 1 wherein the insulation is fabricated from ceramics.

14. The self supporting kiln insulation device as claimed in claim 12 wherein the insulation is fabricated from ceramic fiber.

15. A method of insulating a kiln, said method comprising:
providing insulation modules as claimed in claim 3;
providing a support structure for the insulation modules;
attaching the insulation modules to the support structure.
